(19) United States
(12) Patent Application Publication
(10) Pub. No.: US 2015/0109262 A1
(43) Pub. Date: Apr. 23, 2015

(54) TERMINAL DEVICE, DISPLAY DEVICE, CALIBRATION METHOD AND CALIBRATION PROGRAM

(71) Applicants: Shunichiro Nagao, Kanagawa (JP); Yozo Takehara, Kanagawa (JP); Toshiyuki Murata, Kanagawa (JP)

(72) Inventors: Shunichiro Nagao, Kanagawa (JP); Yozo Takehara, Kanagawa (JP); Toshiyuki Murata, Kanagawa (JP)

(73) Assignee: PIONEER CORPORATION, Kanagawa (JP)

(21) Appl. No.: 14/390,401

(22) PCT Filed: Apr. 5, 2012
(86) PCT No.: PCT/JP2012/059382

§ 371 Date: Oct. 3, 2014

(51) Int. Cl. G06F 3/041; G09G 5/12

(52) U.S. Cl. CPC G06F 3/0418; G09G 5/12; G09G 2354/00; G09G 2380/10; G09G 2370/06
USPC 345/178

(57) ABSTRACT

A terminal device such as a smartphone displays a first image on a display unit, and outputs a second image including the first image as a part to a display device such as a navigation device. Also, the terminal device obtains calibration information indicating a relative positional relation of the first image with respect to the second image from an external server. When a user makes a touch input to the second image displayed on the display device, the input position is transmitted from the display device to the terminal device. The terminal device converts the input position on the second image to the input position on the first image based on the calibration information.

### TECHNICAL FIELD

The present invention relates to calibration of a touch input to a terminal device and a display device connected to each other.

### BACKGROUND TECHNIQUE

In recent years, an on-vehicle device such as a car navigation device and a terminal device such as a smartphone are connected and used.

For example, Patent Reference 1 discloses a system in which a portable terminal and an on-vehicle device are cooperated and an application executed on the terminal device is operated from the on-vehicle device.

Non-Patent Reference 1 proposes a technique of transmitting a display image of a smartphone to an on-vehicle device to be displayed on a display unit of the on-vehicle device and operating an application on the smartphone by a touch input to the display unit of the on-vehicle device, by installing a dedicated module to the application installed in the smartphone.

Patent Reference 2 discloses a method of automatically calibrating a touch panel at the same time as a change of display mode.

### PRIOR ART REFERENCE

### Patent Reference

Patent Reference 1: Japanese Patent Application Laid-open under No. 2010-130670
Patent Reference 2: Japanese Patent Application Laid-open under No. 2006-309466

### Non-Patent Reference

Non-Patent Reference 1: AppRadio Pioneer Electronics USA http://www.pioneerelectronics.com/PUSA/Car/AppRadio

### SUMMARY OF INVENTION

### Problem to be Solved by the Invention

When the display image of the smartphone is transmitted to the display device and displayed like Non-Patent Reference 1, the pixel number and the aspect ratio of the display image are not necessarily the same between the smartphone and the display device. Therefore, according to the model of the smartphone, a black frame area is added at the top, bottom, left and right part of the outputted image in order to maintain the aspect ratio of the outputted image. Namely, the image displayed on the touch panel of the display device is the image created by adding the black frame area to the top, bottom, left and right part of the display image of the smartphone.

In this case, since the black frame area is included in the display image, the display device cannot discriminate whether or not the black frame area is being displayed. Therefore, when a part of the black frame area is touched on the touch panel of the display device, the smartphone may determine that the area within the display image is touched, although the touched area includes no button and the like. In addition, since the area of the image displayed on the touch panel of the display device does not coincide with the actual touch area, the coordinates of the point touched by a user may shift even inside of the black frame area.

In this respect, Patent Reference 2 discloses calibrating the touch panel every time the display mode of the display device is changed. However, by this method, an adjustment of the calibration is required for each of the display devices scheduled to be conformed, at the time of its development. In addition, the calibration is available only to the scheduled display device, and is not available to a new display device.

The above is one example of a problem to be solved by the present invention. It is an object of the present invention to enable easy correction of a shift of an input position caused by the shift of the display images of the terminal device and the display device, even when a new display device is connected.

### Means for Solving the Problem

The invention described in claim is a terminal device comprising: a display unit which displays a first image; an image output unit which outputs a second image including the first image as a part to a display device; an input position obtaining unit which obtains, from the display device, an input position on the second image indicating a position of a touch input that a user made to the second image displayed on the display device; a calibration information obtaining unit which obtains calibration information indicating a relative positional relation of the first image with respect to the second image from an external server; and a converter which converts the input position on the second image to the input position on the first image based on the calibration information.

The invention described in claim is a calibration method executed by a terminal device including a display unit, comprising: a display process which displays a first image on the display unit; an image output process which outputs a second image including the first image as a part to a display device; an input position obtaining process which obtains, from the display device, an input position on the second image indicating a position of a touch input that a user made to the second image displayed on the display device; a calibration information obtaining process which obtains calibration information indicating a relative positional relation of the first image with respect to the second image from an external server; and a conversion process which converts the input position on the second image to the input position on the first image based on the calibration information.

The invention described in claim is a calibration program executed by a terminal device including a display unit and a computer, the program making the computer execute: a display process which displays a first image on the display unit; an image output process which outputs a second image including the first image as a part to a display device; an input position obtaining process which obtains, from the display device, an input position on the second image indicating a position of a touch input that a user made to the second image displayed on the display device; a calibration information obtaining process which obtains calibration information indicating a relative positional relation of the first image with respect to the second image from an external server; and a conversion process which converts the input position on the second image to the input position on the first image based on the calibration information.

The invention described in claim is a display device which communicates with a terminal device, comprising: a display unit which obtains a second image including a first image being displayed on the terminal device as a part from the terminal device, and displays the second image; an input position obtaining unit which obtains an input position on the second image indicating a position of a touch input that a user made to the second image; a calibration information obtaining unit which obtains calibration information indicating a relative positional relation of the first image with respect to the second image from the terminal device; a converter which converts the input position on the second image to the input position on the first image based on the calibration information; and a communication unit which transmits the input position on the first image to the terminal device.

The invention described in claim is a calibration method executed by a display device which includes a display unit and which communicates with a terminal device, comprising: a display process which obtains a second image including a first image being displayed on the terminal device as a part from the terminal device, and displays the second image on the display unit; an input position obtaining process which obtains an input position on the second image indicating a position of a touch input that a user made to the second image; a calibration information obtaining process which obtains calibration information indicating a relative positional relation of the first image with respect to the second image from the terminal device; a conversion process which converts the input position on the second image to the input position on the first image based on the calibration information; and a transmission process which transmits the input position on the first image to the terminal device.

The invention described in claim is a calibration program executed by a display device which includes a display unit and which communicates with a terminal device, the program making the computer execute: a display process which obtains a second image including a first image being displayed on the terminal device as a part from the terminal device, and displays the second image on the display unit; an input position obtaining process which obtains an input position on the second image indicating a position of a touch input that a user made to the second image; a calibration information obtaining process which obtains calibration information indicating a relative positional relation of the first image with respect to the second image from the terminal device; a conversion process which converts the input position on the second image to the input position on the first image based on the calibration information; and a transmission process which transmits the input position on the first image to the terminal device.

### BRIEF DESCRIPTION OF THE DRAWINGS

FIG. 1 illustrates a system according to a first embodiment of the present invention.

FIG. 2 is a block diagram illustrating a functional configuration of the system shown in FIG. 1.

FIG. 3 illustrates an example of an image to which a black frame is added to adjust an aspect ratio.

FIG. 4 illustrates an example of an input position conversion method.

FIG. 5 is a flowchart of input position conversion processing.

FIG. 6 illustrates an example of a calibration image.

FIG. 7 illustrates a system according to a second embodiment of the present invention.

### DETAILED DESCRIPTION OF THE PREFERRED EMBODIMENTS

According to one aspect of the present invention, there is provided a terminal device comprising: a display unit which displays a first image; an image output unit which outputs a second image including the first image as a part to a display device; an input position obtaining unit which obtains, from the display device, an input position on the second image indicating a position of a touch input that a user made to the second image displayed on the display device; a calibration information obtaining unit which obtains calibration information indicating a relative positional relation of the first image with respect to the second image from an external server; and a converter which converts the input position on the second image to the input position on the first image based on the calibration information.

The above terminal device such as a smartphone displays a first image on a display unit, and outputs a second image including the first image as a part to a display device such as a navigation device. Also, the terminal device obtains calibration information indicating a relative positional relation of the first image with respect to the second image from an external server. When a user makes a touch input to the second image displayed on the display device, the input position is transmitted from the display device to the terminal device. The terminal device converts the input position on the second image to the input position on the first image based on the calibration information. Thereby, the input position to the display device can be correctly converted to the input position to the terminal device even if the specifications are different between the display unit of the terminal device and the display unit of the display device.

In one mode of the above terminal device, the calibration information obtaining unit stores the calibration information obtained from the external server into a storage unit in the terminal device, and the converter uses the calibration information stored in the storage unit when the calibration information obtained in the past is stored in the storage unit. Thereby, it becomes unnecessary to obtain the calibration information every time from the external server, and the communication amount can be reduced.

Another mode of the above terminal device further comprises: a calibration image output unit which supplies a calibration image to the display device; a calibration input position obtaining unit which obtains, from the display device, a calibration input position indicating a position of a touch input that the user made to the calibration image displayed on the display device; a calibration information generating unit which generates the calibration information based on the obtained calibration input position; and a communication unit which transmits the generated calibration information to the external server.

In this mode, when the calibration information cannot be obtained from the external server, the calibration information can be generated based on the input by the user to the calibration image. Also, by uploading the generated calibration information to the server, many users can share the calibration information.

According to another aspect of the present invention, there is provided a calibration method executed by a terminal device including a display unit, comprising: a display process which displays a first image on the display unit; an image output process which outputs a second image including the first image as a part to a display device; an input position obtaining process which obtains, from the display device, an input position on the second image indicating a position of a touch input that a user made to the second image displayed on the display device; a calibration information obtaining process which obtains calibration information indicating a relative positional relation of the first image with respect to the second image from an external server; and a conversion process which converts the input position on the second image to the input position on the first image based on the calibration information. Thereby, the input position to the display device can be correctly converted to the input position to the terminal device even if the specifications are different between the display unit of the terminal device and the display unit of the display device.

According to another aspect of the present invention, there is provided a calibration program executed by a terminal device including a display unit and a computer, the program making the computer execute: a display process which displays a first image on the display unit; an image output process which outputs a second image including the first image as a part to a display device; an input position obtaining process which obtains, from the display device, an input position on the second image indicating a position of a touch input that a user made to the second image displayed on the display device; a calibration information obtaining process which obtains calibration information indicating a relative positional relation of the first image with respect to the second image from an external server; and a conversion process which converts the input position on the second image to the input position on the first image based on the calibration information. Thereby, the input position to the display device can be correctly converted to the input position to the terminal device even if the specifications are different between the display unit of the terminal device and the display unit of the display device.

According to another aspect of the present invention, there is provided a display device which communicates with a terminal device, comprising: a display unit which obtains a second image including a first image being displayed on the terminal device as a part from the terminal device, and displays the second image; an input position obtaining unit which obtains an input position on the second image indicating a position of a touch input that a user made to the second image; a calibration information obtaining unit which obtains calibration information indicating a relative positional relation of the first image with respect to the second image from the terminal device; a converter which converts the input position on the second image to the input position on the first image based on the calibration information; and a communication unit which transmits the input position on the first image to the terminal device.

The above display device is a navigation device, for example, which is configured to communicate with a smartphone serving as a terminal device. The display device receives the second image including the first image being displayed on the terminal device as a part, and displays it on the display unit. Also, the display device obtains the calibration information indicating the relative positional relation of the first image with respect to the second image from the terminal device. When the user makes a touch input to the second image, the display device obtains the input position, converts it to the input position on the first image based on the calibration information, and transmits it to the terminal device. Thereby, the input position to the display device can be correctly converted to the input position to the terminal device even if the specifications are different between the display unit of the terminal device and the display unit of the display device.

According to another aspect of the present invention, there is provided a calibration method executed by a display device which includes a display unit and which communicates with a terminal device, comprising: a display process which obtains a second image including a first image being displayed on the terminal device as a part from the terminal device, and displays the second image on the display unit; an input position obtaining process which obtains an input position on the second image indicating a position of a touch input that a user made to the second image; a calibration information obtaining process which obtains calibration information indicating a relative positional relation of the first image with respect to the second image from the terminal device; a conversion process which converts the input position on the second image to the input position on the first image based on the calibration information; and a transmission process which transmits the input position on the first image to the terminal device. Thereby, the input position to the display device can be correctly converted to the input position to the terminal device even if the specifications are different between the display unit of the terminal device and the display unit of the display device.

According to another aspect of the present invention, there is provided a calibration program executed by a display device which includes a display unit and which communicates with a terminal device, the program making the computer execute: a display process which obtains a second image including a first image being displayed on the terminal device as a part from the terminal device, and displays the second image on the display unit; an input position obtaining process which obtains an input position on the second image indicating a position of a touch input that a user made to the second image; a calibration information obtaining process which obtains calibration information indicating a relative positional relation of the first image with respect to the second image from the terminal device; a conversion process which converts the input position on the second image to the input position on the first image based on the calibration information; and a transmission process which transmits the input position on the first image to the terminal device. Thereby, the input position to the display device can be correctly converted to the input position to the terminal device even if the specifications are different between the display unit of the terminal device and the display unit of the display device.

Preferably, the calibration program described above can be handled in a manner stored in a storage medium.

### EMBODIMENTS

Preferred embodiments of the present invention will be described below with reference to the attached drawings.

### 1st Embodiment

### Configuration

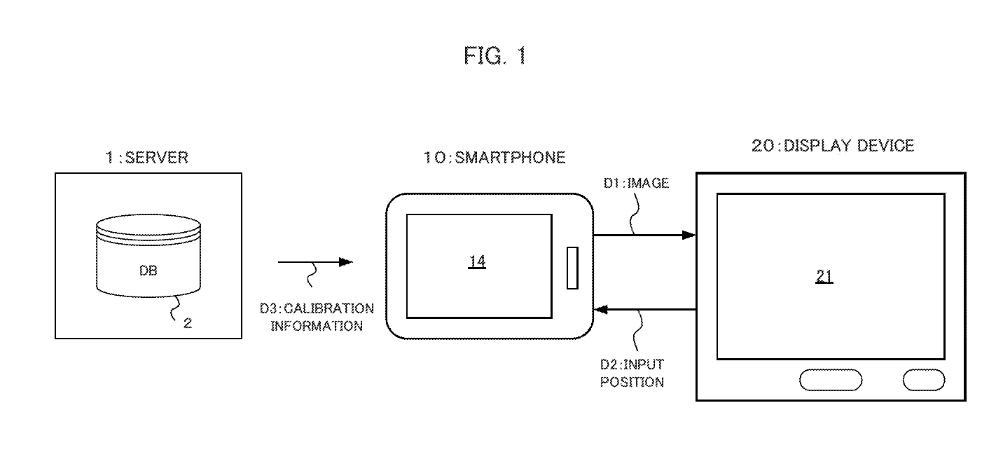

FIG. 1 illustrates a configuration of a system including a terminal device according to a first embodiment of the present invention. As shown in FIG. 1, the system includes a server 1, a smartphone 10 and a display device 20.

The smartphone 10 and the display device 20 are configured to be able to communicate with each other. The smartphone 10 corresponds to the terminal device of the present invention. The display device 20 is a device loaded on a vehicle, such as a navigation device or an on-vehicle AV equipment.

In this system, the display image of the smartphone 10 is transmitted to the display device 20 and is displayed on the display device 20. When a user makes an operational input to the display device 20, the display device 20 transmits a signal corresponding to the operational input to the smartphone 10. Thus, the user can operate the smartphone 10 by making the operational input to the display device 20.

The smartphone 10 displays the image on a touch panel (display unit) 14 using a liquid crystal display, for example. The smartphone 10 transmits the image D1 displayed on the touch panel 14 to the display device 20 via HDMI (High Definition Multimedia Interface), for example.

The display device 20 includes a touch panel (display device) 21 using a liquid crystal display, for example. The display device 20 receives the image D1 from the smartphone 10 and displays it on the touch panel 21. Also, the display device 20 detects the operational input that the user made to the touch panel 21, and transmits its input position (position coordinates) D2 to the smartphone 10. The input position D2 is transmitted to the smartphone 10 by SPP (Serial Port Profile) of Bluetooth (Registered Trademark), for example.

The server 1 includes a database 2. The database 2 stores calibration information as described later. The smartphone 10 accesses the server 1 by a wireless communication function, and is able to download the calibration information D3.

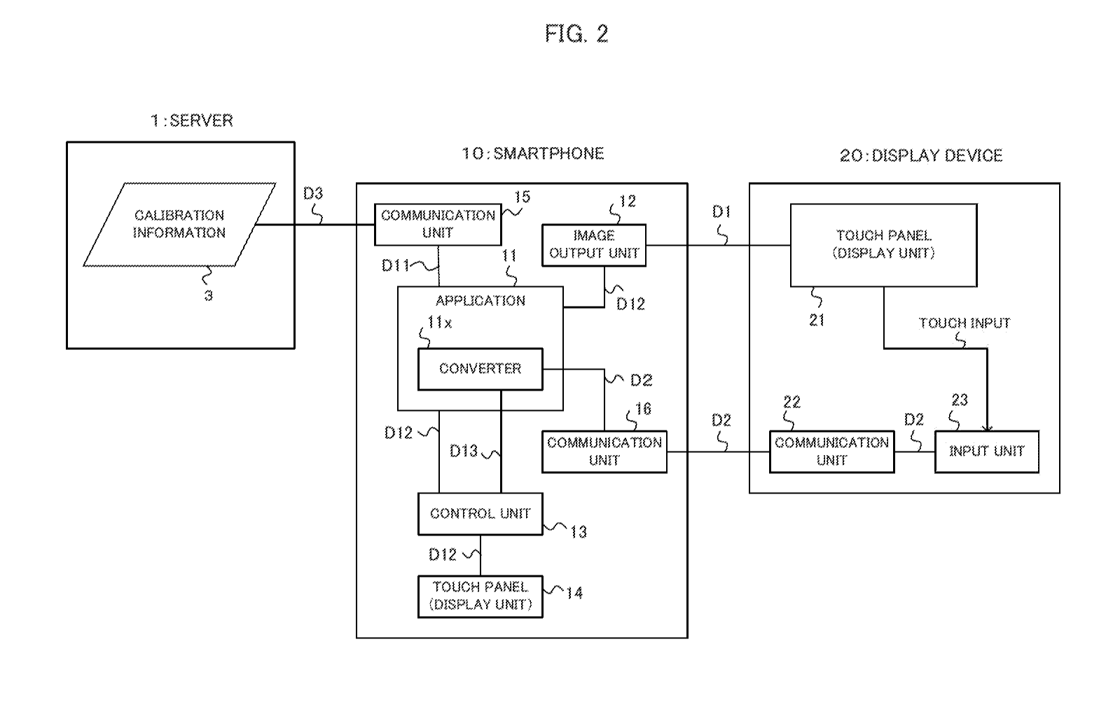

FIG. 2 is a block diagram illustrating a functional configuration of the system shown in FIG. 1. The smartphone 10 includes an application 11, an image output unit 12, a control unit 13, the touch panel 14 and communication units 15 and 16.

The application 11 is executed on the smartphone 10, and is used to operate the smartphone 10 by the display device 20 as described above. The application 11 is realized by a computer such as a CPU which executes a program prepared in advance. The application 11 functions as an input position obtaining unit, a calibration information obtaining unit, a calibration image output unit, a calibration position information obtaining unit and a calibration information generation unit according to the present invention.

The image output unit 12 receives the display image of the smartphone 10 from the application 11, and transmits it to the display device 20 as the image D1.

The control unit 13 controls the smartphone 10 in its entirety, and is actually realized by an OS and a basic application installed 20 in the smartphone 10. The control unit 13 displays the image D12 generated by various applications operating on the smartphone 10 on the touch panel 14 and also supplies the image D12 to the application 11.

The communication unit 15 has a communication function to perform the wireless communication with the server 1 and receive the calibration information D3 from the server 1. The communication unit 16 has a communication function to receive the input position D2 corresponding to the user's operational input from the display device 20.

Meanwhile, the display device 20 includes the touch panel 21, a communication unit 22 and an input unit 23. The touch panel 21 is used when the user makes a desired operational input. The input unit 23 detects the operational input that the user made to the touch panel 21, and supplies its input position D2 to the communication unit 22. The communication unit 22 transmits the input position D2 to the smartphone 10.

Next, the processing executed by the application 11 will be described. The application 11 receives the image D12 generated by various applications executed on the smartphone 10 from the control unit 13, and supplies it to the image output unit 12. The image output unit 12 transmits the image D12 to the display device 20 as the image D1. The display device 20 displays the received image D1 on the touch panel 21. Thus, the display image of the smartphone 10 is displayed on the touch panel 21.

The user watches the display image on the display device 20 and makes the operational input to the touch panel 21 of the display device 20. Specifically, the user makes the operational input by touching the button in the image displayed on the touch panel 21. This operational input is detected by the input unit 23, and the input position D2 corresponding to the operational input is transmitted to the smartphone 10 via the communication unit 22.

In the smartphone 10, the communication unit 16 receives the input position D2 and supplies it to the application 11. The application 11 obtains the input position of the user's operational input to the smartphone 10, and supplies the input position to the control unit 13. The control unit 13 executes the processing corresponding to the user's operational input based on the display image D12 and the input position received from the application 11. Thus, the smartphone 10 can be operated from the display device 20.

(Conversion Method of Input Position)

When the image of the smartphone 10 is transmitted to and displayed on the display device 20, it is not necessarily ensured that the specifications, specifically the pixel number and the aspect ratio, of the touch panel 14 of the smartphone 10 and the touch panel 21 of the display device 20 coincide with each other. Therefore, there is a case that the smartphone 10 adds a black frame at the top, bottom, left and right part of the image in order to adjust the pixel number and the aspect ratio. For example, the aspect ratio of the transmitted image is fixed to 16:9 or 4:3 according to the HDMI standard mentioned above, whereas the aspect ratio of the touch panel 14 of the smartphone 10 is different according to the model of the smartphone 10. Therefore, when outputting the image according to HDMI, the smartphone 10 may add the black frame different according to the model by the image output unit 12 thereby to adjust the aspect ratio.

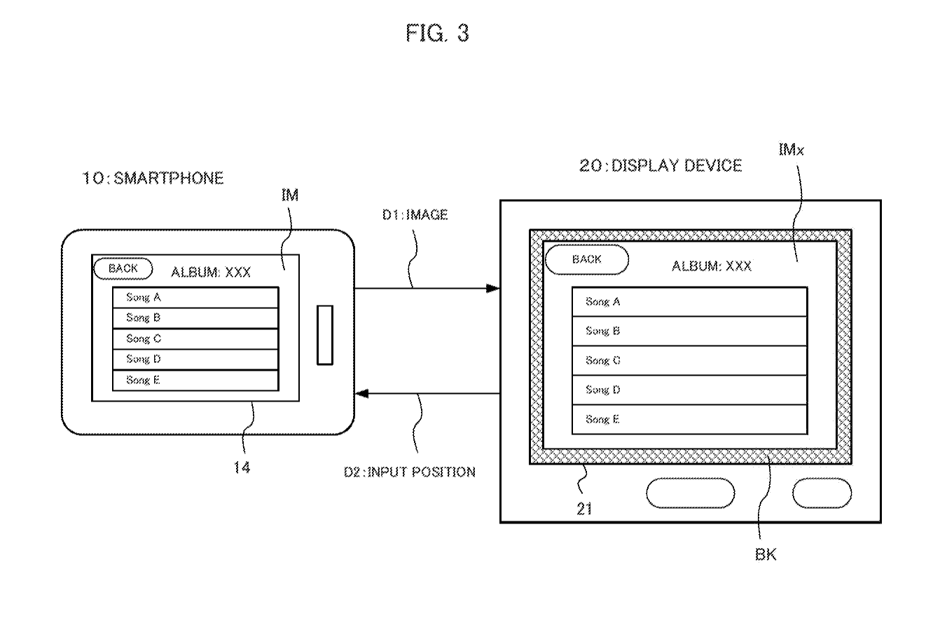

FIG. 3 illustrates an example of the image to which the black frame is added in order to adjust the aspect ratio. The image IM is displayed on the touch panel 14 of the smartphone 10. The image IM includes a list of plural songs belonging to a certain album and the “BACK” button to return to the previous screen. When this image IM is transmitted to and displayed on the display device 20, the smartphone 10 creates the image IMx by adjusting the aspect ratio to be in conformity with the HDMI standard, and transmits the image IMx to the display device 20 as the image D1. Thus, the image IMx displayed on the touch panel 21 of the display device 20 is the image created by adding the black frame area BK to the outer circumference of the image IM displayed on the smartphone 10.

In this case, since the black frame area BK is also displayed on the touch panel 21, the user can make the touch input to the black frame area BK. However, since the black frame area Bk does not exist in the image IM of the smartphone 10 and is not the operational input area, the touch input to the black area Bk should be treated as an inappropriate input. In addition, since the image IM displayed on the smartphone 10 and the image IMx displayed on the display device 20 have different scales, it is necessary to convert the position coordinates of the touch input to the area inside the black frame area BK to the position coordinates on the image IM of the smartphone 10. In this view, the application 11 functions as a converter 11x to execute this conversion in this embodiment.

Specifically, the converter 11x receives the input position D2 on the touch panel 21 (i.e., the input position on the image IMx) from the display device 20, and converts it to the input position on the touch panel 14 of the smartphone 10 (i.e., the input position on the image IM). At this time, the converter 11x mainly executes the following two processing.

First, when the touch input to the black frame area BK is a simple touch (i.e., a type of touch that contacts substantially one point and is then released without the movement of the touched position), the converter 11x simply neglects the touch input. In contrast, when the touch input to the black frame area Bk is the input involving the movement of the touched position, such as a so-called “drag”, the converter 11x converts the input position of the touch input to the black frame area BK to the position nearest to the input position in the area inside the black frame area BK (hereinafter referred to as “regular area”). By either of the above methods, the converter 11x handles the touch input to the black frame area BK.

Second, the converter 11x converts the input position of the touch input to the regular area to the corresponding position on the touch panel 14 of the smartphone 10. By this, even if the pixel number of the touch panel 14 of the smartphone 10 is different from the pixel number of the touch panel 21 of the display device 20, the input position to the touch panel 21 of the display device 20 can be correctly converted to the input position to the touch panel 14 of the smartphone 10.

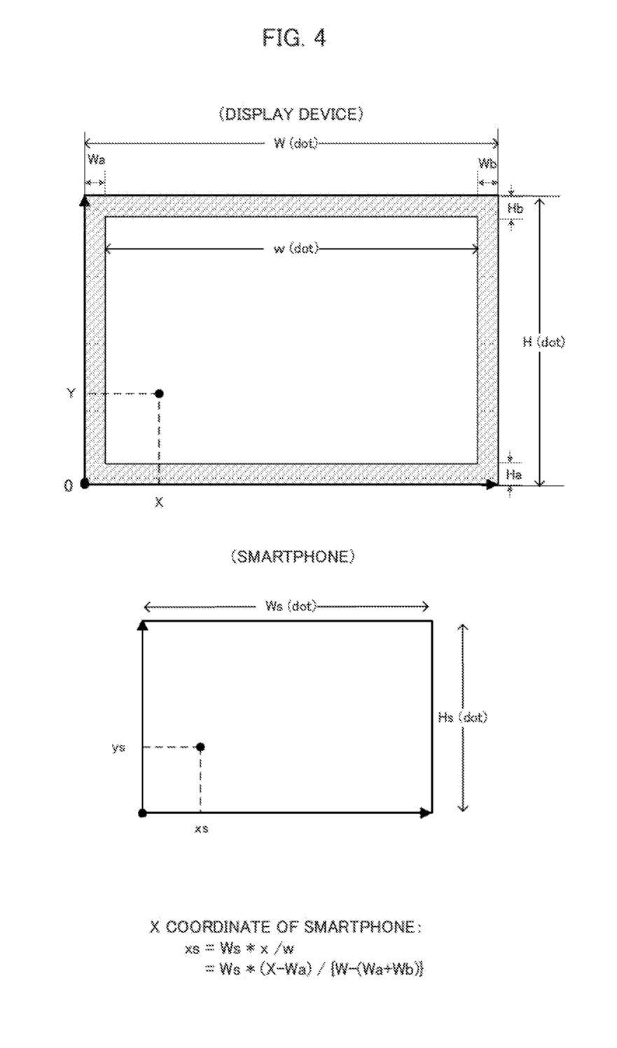

FIG. 4 illustrates an example of the above-described conversion method. First, the horizontal direction will be described. It is assumed that the dot number of the touch panel 21 of the display device 20 in the horizontal direction is “W”, and each of the left and right widths of the black frame area BK displayed on the touch panel 21 are “Wa” and “Wb”. Also, it is assumed that the dot number of the touch panel 14 of the smartphone 10 in the horizontal direction is “Ws”.

In this case, the input position “X” on the touch panel 21 of the display device 20 is converted to the input position “xs” on the touch panel 14 of the smartphone 10 by the following equation:

xs=0:when X<Wa,

xs=Ws·(X−Wa)/{W−(Wa+Wb)}:when Wa<x<Wb,

xs=Ws:when X>(W−Wb)

The same may apply to the vertical direction. It is assumed that the dot number of the touch panel 21 of the display device 20 in the vertical direction is “H”, each of the top and bottom widths of the black frame area BK displayed on the touch panel 21 are “Hb” and “Ha”, and the dot number of the touch panel 14 of the smartphone 10 in the vertical direction is “Hs”.

In this case, the input position “Y” on the touch panel 21 of the display device 20 is converted to the input position “ys” on the touch panel 14 of the smartphone 10 by the following equation:

ys=0:when Y<Ha,

ys=Hs·(X−Ha)/{H−(Ha+Hb)}:when Ha<y<Hb,

ys=Hs:when Y>(H−Hb)

It is noted that, when the touch input to the black frame area BK is the simple touch, the converter 11x may neglect the touch input as mentioned above.

According to the above-described conversion method, even when the image IMx including the black frame area BK is displayed on the touch panel 21 of the display device 20, the input position to the touch panel 21 can be correctly converted to the input position to the touch panel 14 of the smartphone 10.

In order to perform the above-described conversion, the dot numbers (the dot number in the vertical direction: Hs, the dot number in the horizontal direction: Ws) of the touch panel 14 of the smartphone 10, the dot numbers (the dot number in the vertical direction: H, the dot number in the horizontal direction: W) of the touch panel 21 of display device 20, and the widths of the top, bottom, left and right part of the black frame area BK (Wa, Wb, Ha, Hb) are needed. The application 11 can obtain the dot numbers of the touch panel 14 of the smartphone 10 from the control unit 13 of the smartphone 10, and can obtain the dot numbers of the touch panel 21 of the display device 20 from the display device 20. However, the widths of the top, bottom, left and right part of the black frame area BK are not normally owned by the smartphone 10 and the display device 20.

In this view, the application 11 obtains the widths of the top, bottom, left and right part of the black frame area BK from the server 1 as the calibration information D3. Specifically, the widths of the top, bottom, left and right part of the black frame area BK is determined based on the specification of the touch panel 14 of the smartphone 10 and the specification of the touch panel 21 of the display device 20. Therefore, the server 1 retains the widths of the top, bottom, left and right part of the black frame area BK in correspondence with the combination of the smartphone 10 and the display device 20 as the calibration information D3 in advance. For example, the server 1 stores the calibration information D3 indicating the widths of the top, bottom, left and right part of the black frame area BK in correspondence with the combination of the ID indicating the model name of the smartphone 10 and the ID indicating the model name of the display device 20. When the smartphone 10 is connected to the display device 20, the smartphone 10 obtains the ID of the display device 20, transmits the ID of the smartphone 10 and the ID of the display device 20 to the server 1, and obtains the calibration information D3 corresponding to the combination of those IDs. Then, the smartphone 10 uses the obtained calibration information D3 to convert the input position to the touch panel 21 of the display device 20 to the input position to the touch panel 14 of the smartphone 10.

(Input Position Conversion Processing)

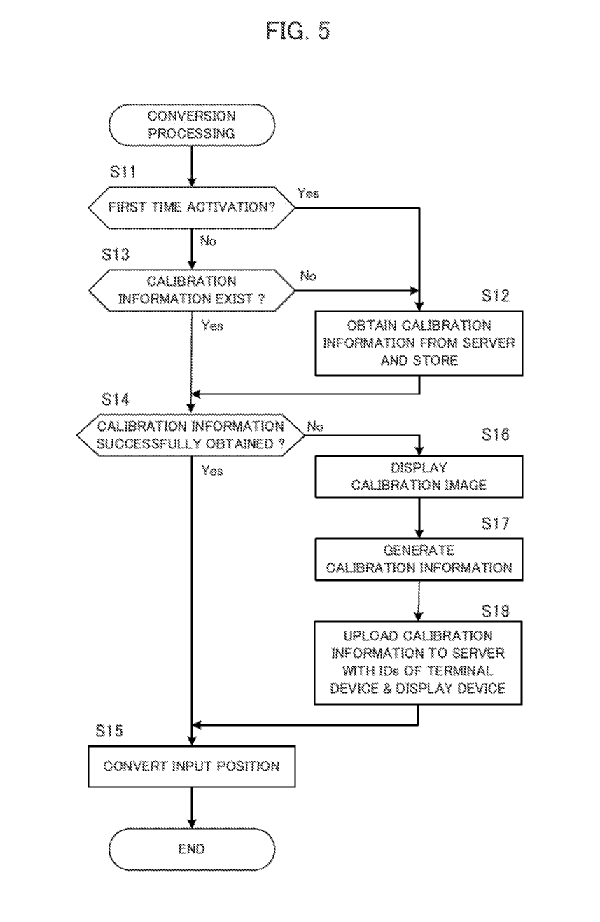

FIG. 5 is a flowchart of input position conversion processing. This processing is executed by the application 11 in the smartphone 10. It is assumed that the smartphone 10 and the display device 20 can communicate with each other. This processing is executed when the application 11 is activated on the smartphone 10.

When the application 11 is activated, it is determined whether or not it is the first time activation or not (step S11). This determination is made based on processing history information stored in the application 11, for example.

When it is the first time activation (step S11; Yes), normally the application 11 does not have the calibration information yet. Therefore, the application 11 specifies the ID of the smartphone 10 and the ID of the display device 20 to request the calibration information corresponding to the combination of those IDs, and obtains the corresponding calibration information to store it in the storage unit of the smartphone 10 (step S12). Then, the processing goes to step S14.

On the other hand, when it is not the first time activation (step S11; No), the application 11 determines whether or not the calibration information exists in the storage unit of the smartphone 10 (step S13). The calibration information in this case means the calibration information corresponding to the combination of the smartphone 10 and the display device 20 currently used. When the calibration information does not exist (step S13; No), the application 11 obtains the calibration information from the server 1 (step S12). On the other hand, when the calibration information exists (step S13; Yes), the processing goes to step S14.

In step S14, the application 11 determines whether or not the calibration information is successfully obtained. Namely, the application 11 determines whether or not the calibration information is prepared by the processing of step S12 or S13. When the application 11 successfully obtains the calibration information (step S14; Yes), the processing goes to step S15.

On the other hand, when the application does not successfully obtain the calibration information (step S14; No), the application 11 executes the processing of generating the calibration information by itself by utilizing the display device 20. Specifically, the application 11 transmits the calibration image to the display device 20 to display the calibration image on the touch panel 21 of the display device 20 (step S16). As the reason why the calibration information is not successfully obtained, there may be a case where the server 1 does not have the calibration information corresponding to the combination of the smartphone 10 and the display device 20, or a case where the communication with the server 1 cannot be normally executed.

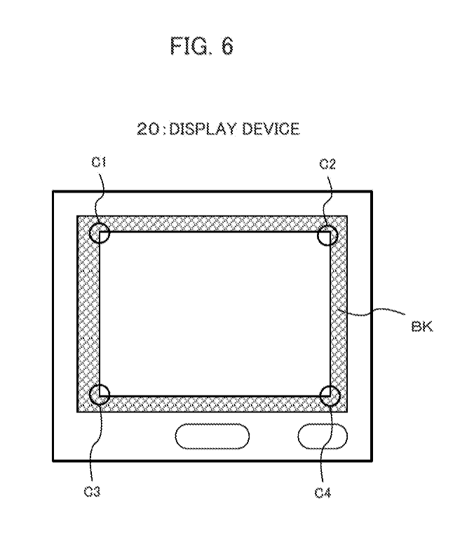

FIG. 6 shows an example of the calibration image. In the example of FIG. 6, the application 11 transmits the image, expressing the regular area by the light and shade in order to distinguish it from the black frame area BK, to the display device 20 as the calibration image. In this case, the calibration image includes the black frame area BK based on the difference of the pixel numbers and/or the aspect ratio between the touch panel 14 of the smartphone 10 and the touch panel 21 of the display device 20. Further, the application 11 indicates the inner four corners of the black frame area BK by the marks C1 to C4 to make the user touch those inner four corners of the black frame area BK. When the user touches the positions of the marks C1 to C4, the display device 20 acquires the coordinates of each position, and transmits them to the smartphone 10.

The application 11 receives the position coordinates corresponding to the inner four corners of the black frame area BK, generates the calibration information by calculating the widths of the top, bottom, left and right part of the black frame area BK, and then stores it in the storage unit of the smartphone 10 (step S17). Further, the application 11 uploads the calibration information thus generated to the server 1 together with the ID of the smartphone 10 and the ID of the display device 20 (step S18). By this, the calibration information corresponding to the combination of the smartphone and the display device is prepared, and it can be used by another user after that time. Then, the processing goes to step S15.

In step S15, the application 11 converts the input position by using the prepared calibration information (step S15). Namely, the application 11 obtains the input position to the touch panel 21 of the display device 20 from the display device 20, and converts it to the input position to the touch panel 14 of the smartphone 10. Then, the application 11 supplies the input position D13 obtained by the conversion to the control unit 13 of the smartphone 13, and ends the conversion processing. It is noted that the control unit 13 of the smartphone 10 processes the operational input by the user based on the input position D13.

As described above, according to the first embodiment, even when the specification such as the pixel number and/or the aspect ratio is different between the touch panel 14 of the smartphone 10 and the touch panel 21 of the display device 20 and therefore the black frame area BK is displayed in the display image of the display device 20, the input position to the touch panel 21 of the display device 20 can be correctly converted to the input position to the touch panel 14 of the smartphone 10.

When the calibration information used to convert the input position is stored in the smartphone 10, the application 11 uses it, and therefore the application 11 does not have to download the calibration information from the server 1. In a case where the application 11 cannot obtain the calibration information from the server 1, the application 11 generates the calibration information based on the input by the user by using the calibration image as shown in FIG. 6. Therefore, even in a case of using a smartphone or a display device of new model whose calibration information does not exist yet in the server 1, the conversion of the input position is possible. Generating the calibration information by using the calibration image as described above is performed not only in a case where the application 11 cannot obtain the calibration information. For example, the processing of generating the calibration information may be registered in a menu of the smartphone 10 and may be performed when the user desires.

Since the application 11 uploads the calibration information thus generated to the server 1, other users can use the calibration information after that. If the server 1 receives the calibration information from plural smartphones, it may retain the calibration information of high accuracy by analyzing the accuracy of them and/or averaging them.

### 2nd Embodiment

While the input position conversion processing is executed on the side of the smartphone 10 in the first embodiment described above, the input position conversion processing is executed on the side of the display device 20 in the second embodiment described below.

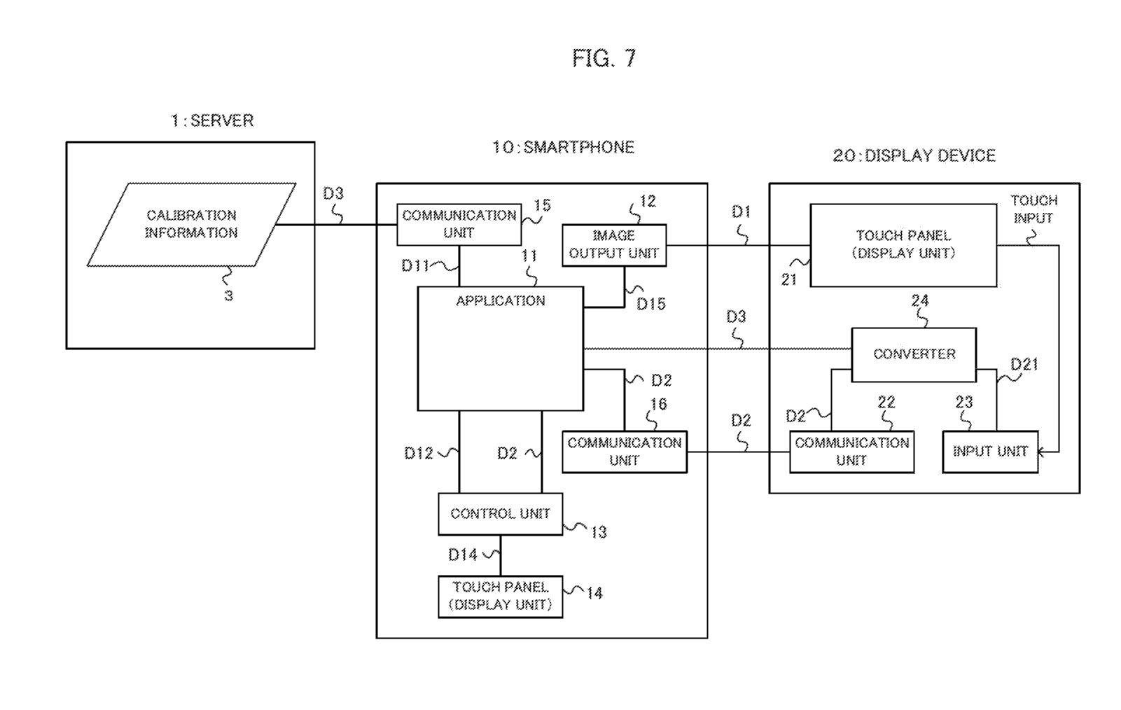

FIG. 7 illustrates a system according to the second embodiment. As is understood by the comparison with FIG. 1, a converter 24 is provided in the display device 20 instead of the converter 11x in the application 11 of the smartphone 10. Also, the application 11 supplies the calibration information D3 obtained from the server 1 to the converter 24 of the display device 20. It is noted that the calibration information D3 may be supplied to the display device 20 by using Bluetooth or by providing a new interface, for example.

In the display device 20, the input unit 23 detects the user's touch input to the touch panel 21, and supplies the input position D21 to the converter 24. The converter 24 converts the input position D21 on the touch panel 21 of the display device 20 to the input position D2 on the touch panel 14 of the smartphone 10 by the same method as the first embodiment, and transmits the input position D2 after the conversion to the smartphone 10. Namely, in the second embodiment, the display device 20 transmits the input position on the display device 20 to the smartphone 10 after converting it to the input position adapted to the touch panel 14 of the smartphone 10. Therefore, the application 11 of the smartphone 10 can execute necessary processing by using the input position D2 received from the display device 20 as it is.

The second embodiment has the following advantage that the first embodiment does not have. In the first embodiment, even when the user makes the touch input within the black frame area BK, the input position is transmitted to the smartphone 10, and the converter 11x converts it or neglects it. Therefore, the input position is transmitted to the smartphone 10 even if the input is not treated as an appropriate input eventually. In contrast, in the second embodiment, the touch input to the black frame area BK is neglected by the converter 24. Namely, since the display device 20 does not transmit the input position, transmission of unnecessary information can be avoided.

In the second embodiment, the calibration information D3 once obtained from the server 1 may be stored in the smartphone 10 or stored in the display device 20. In a case where the smartphone 10 stores the calibration information D3, the smartphone transmits the calibration information D3 to the display device 20 to be used by the converter 24 in the display device 20 every time the smartphone 10 is connected to the display device 20. On the other hand, in a case where the display device 20 stores the calibration information D3, the display device 20 does not have to obtain the calibration information D3 from the smartphone 10.

### Modified Example

In the embodiments described above, when the calibration information cannot be obtained, the application 11 generates the calibration information by using the calibration image (See. steps S16 to S17 in FIG. 5, and FIG. 6). At that time, the connection authentication processing between the smartphone 10 and the display device 20 may be executed at the same time. The connection authentication processing is processing which confirms that the smartphone 10 and the display device 20 are connected with each other. As a specific method, numbers indicating the touching order are displayed at the marks C1 to C4 at the inner corners of the black frame area BK shown in FIG. 6. The smartphone 10 receives the information of the touching order (e.g., the time of the touch) from the display device 20 in addition to the input positions of the touch inputs, and determines that the authentication is successful if the user correctly made the touch inputs in the touching order. By this, the processing of generating the calibration information and the connection authentication processing can be executed at the same time.

### INDUSTRIAL APPLICABILITY

This invention can be used in a case where a terminal device such as a smartphone is connected to a display device, not only an on-vehicle display device, having an operation unit of a touch input.

### DESCRIPTION OF REFERENCE NUMBERS

1 Server
10 Smartphone
11 Application
11x, 24 Converter
12 Image Output Unit
13 Control Unit
14, 21 Touch Panel
20 Display Device

1-9. (canceled)

10. A calibration method executed by a terminal device including a display unit, comprising:
a display process which displays a first image on the display unit;
an image output process which outputs a second image including the first image as a part to a display device;
an input position obtaining process which obtains, from the display device, an input position on the second image indicating a position of a touch input that a user made to the second image displayed on the display device;
a calibration information obtaining process which obtains calibration information indicating a relative positional relation of the first image with respect to the second image from an external server; and
a conversion process which converts the input position on the second image to the input position on the first image based on information indicating sizes of the first image and the second image and the calibration information.

11. The calibration method according to claim 10,
wherein the calibration information obtaining process stores the calibration information obtained from the external server into a storage unit in the terminal device, and
wherein the conversion process uses the calibration information stored in the storage unit when the calibration information obtained in the past is stored in the storage unit.

12. The calibration method according to claim 10, further comprising:
a calibration image output process which supplies a calibration image to the display device;
a calibration input position obtaining process which obtains, from the display device, a calibration input position indicating a position of a touch input that the user made to the calibration image displayed on the display device;
a calibration information generating process which generates the calibration information based on the obtained calibration input position; and
a communication process which transmits the generated calibration information to the external server.

13. A calibration program stored in a non-transitory computer-readable medium and executed by a terminal device including a display unit and a computer, the program making the computer execute:
a display process which displays a first image on the display unit;
an image output process which outputs a second image including the first image as a part to a display device;
an input position obtaining process which obtains, from the display device, an input position on the second image indicating a position of a touch input that a user made to the second image displayed on the display device;
a calibration information obtaining process which obtains calibration information indicating a relative positional relation of the first image with respect to the second image from an external server; and
a conversion process which converts the input position on the second image to the input position on the first image based on information indicating sizes of the first image and the second image and the calibration information.

14. The calibration program according to claim 13,
wherein the calibration information obtaining process stores the calibration information obtained from the external server into a storage unit in the terminal device, and
wherein the conversion process uses the calibration information stored in the storage unit when the calibration information obtained in the past is stored in the storage unit.

15. The calibration program according to claim 13, further making the computer execute:
a calibration image output process which supplies a calibration image to the display device;
a calibration input position obtaining process which obtains, from the display device, a calibration input position indicating a position of a touch input that the user made to the calibration image displayed on the display device;
a calibration information generating process which generates the calibration information based on the obtained calibration input position; and
a communication process which transmits the generated calibration information to the external server.

16. A calibration method executed by a display device which includes a display unit and which communicates with a terminal device, comprising:
a display process which obtains a second image including a first image being displayed on the terminal device as a part from the terminal device, and displays the second image on the display unit;
an input position obtaining process which obtains an input position on the second image indicating a position of a touch input that a user made to the second image;
a calibration information obtaining process which obtains calibration information indicating a relative positional relation of the first image with respect to the second image from an external server via the terminal device;
a conversion process which converts the input position on the second image to the input position on the first image based on information indicating sizes of the first image and the second image and the calibration information; and
a transmission process which transmits the input position on the first image to the terminal device.
